(19) United States
(12) Patent Application Publication
(10) Pub. No.: US 2017/0194656 A1
(43) Pub. Date: Jul. 6, 2017

(54) PERFORATED 2D FLOW BATTERY SEPARATORS

(71) Applicant: Lockheed Martin Corporation, Bethesda, MD (US)

(72) Inventors: Steven L. Sinsabaugh, Abingdon, MD (US); Han Liu, Timonium, MD (US)

(21) Appl. No.: 14/984,333

(22) Filed: Dec. 30, 2015

(51) Int. Cl. H01M 8/02; H01M 8/18; H01M 8/20; H01M 8/04

(52) U.S. Cl. CPC H01M 8/0239; H01M 8/04283; H01M 8/188; H01M 8/20

(57) ABSTRACT

A two-dimensional (2D) separator system for use in a flow battery, and a flow battery utilizing such 2D separator system are disclosed. The 2D separator system comprises a relatively thin layer of molecules, in one embodiment a sheet of 2D material, having perforations of a size configured to facilitate transfer of a common counter ion between an anolyte and a catholyte, and to inhibit transfer of one or more electro-active ions between the anolyte and the catholyte.

### TECHNICAL FIELD

The embodiments relate to flow batteries and, in particular, to two-dimensional flow battery separators that separate an anolyte half-cell from a catholyte half-cell.

### BACKGROUND

Energy storage devices are of increasing interest for use in large-scale energy transmission and distribution systems. A flow battery is one such energy storage device. A flow battery is an electrochemical device that can reversibly convert energy between electrical energy (sourced from or sent to an external electrical power grid) and chemical energy, typically in the form of changing charge states of reduction-oxidation (redox) species in electrolyte solutions. The electrolyte solutions in a flow battery are stored in external tanks and are introduced into flow battery cells during operation.

In a flow battery, a separator, sometimes referred to as a membrane, separates a catholyte (i.e., a positive electrolyte) half-cell from an anolyte (i.e., a negative electrolyte) half-cell. Ideally, the separator allows one or more common counter ion species to flow between the catholyte half-cell and the anolyte half-cell and inhibits the transfer of one or more electro-active ion species between the catholyte half-cell and the anolyte half-cell.

Conventional separators, however, do not operate ideally and typically allow for the transfer of some electro-active ion species between the catholyte half-cell and the anolyte half-cell, which reduces the efficiency of the battery. Moreover, conventional separators are relatively thick and have a relatively high areal resistance (ohm cm²). This results in energy storage efficiency losses, and ultimately economic losses for the energy storage operator.

### SUMMARY

The embodiments relate to a two-dimensional (2D) separator system for use in a flow battery, and a flow battery utilizing such 2D separator system. The 2D separator system comprises a relatively thin layer of molecules, in one embodiment a sheet of graphene, having perforations of a size configured to facilitate transfer of a common counter ion between an anolyte and a catholyte, and to inhibit transfer of one or more electro-active ions between the anolyte and the catholyte. Among other advantages, the embodiments provide a 2D separator system for a flow battery that reduces areal resistance and greatly reduces or eliminates leakage of electro-active ions across the separator system, increasing efficiency of the flow battery. The 2D separator system also has a high temperature tolerance and a high chemical resistance.

In one embodiment, a flow battery is provided. The flow battery includes an anolyte tank that is configured to maintain an anolyte. An anolyte half-cell is fluidically coupled to the anolyte tank. A first pump is configured to circulate the anolyte between the anolyte tank and the anolyte half-cell. A first electrode is at least partially exposed to the anolyte half-cell. The flow battery also includes a catholyte tank that is configured to maintain a catholyte. A catholyte half-cell is fluidically coupled to the catholyte tank. A second pump is configured to circulate the catholyte between the catholyte tank and the catholyte half-cell. A second electrode is at least partially exposed to the catholyte half-cell. The flow battery further includes a separator system that separates the anolyte half-cell from the catholyte half-cell. The separator system includes a sheet of graphene having a plurality of perforations. The plurality of perforations comprises a size configured to facilitate transfer of a common counter ion between the anolyte and the catholyte, and to inhibit transfer of one or more electro-active ions between the anolyte and the catholyte.

In one embodiment, the separator system further includes a support structure configured to support the sheet of graphene. In one embodiment, the support structure comprises a first polymer sheet having a plurality of openings that have a greater diameter than a diameter of the plurality of perforations of the sheet of graphene. The sheet of graphene has a first side and a second side, and the first polymer sheet is coupled to the first side. In another embodiment, the support structure further comprises a second polymer sheet having a plurality of openings that have a greater diameter than a diameter of the plurality of perforations of the sheet of graphene, and the second polymer sheet is coupled to the second side.

In one embodiment, the sheet of graphene has a thickness less than or equal to 1 nanometer.

In another embodiment, a separator system for a flow battery is provided. The separator system includes a sheet of graphene having a plurality of perforations. The plurality of perforations comprises a size configured to facilitate transfer of a common counter ion between an anolyte and a catholyte, and to inhibit transfer of one or more electro-active ions between the anolyte and the catholyte.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a flow battery utilizing a two-dimensional (2D) separator system according to one embodiment;

FIG. 2 is a diagram of a separator system according to one embodiment;

FIG. 3 is a block diagram of a flow battery cell according to one embodiment; and

FIG. 4 is a block diagram of an illustrative system and process suitable for manufacturing a 2D separator system.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The use herein of ordinals in conjunction with an element is solely for distinguishing what might otherwise be similar or identical labels, such as “first pump” and “second pump,” and does not imply a priority, a type, an importance, or other attribute, unless otherwise stated herein. The term “about” used herein in conjunction with a numeric value means any value that is within a range of ten percent greater than or ten percent less than the numeric value.

The phrase “anolyte” refers to an electrolyte containing one or more active species that have lower electrochemical potential compared to that of a catholyte. The phrase “catholyte” refers to an electrolyte containing one or more active species that have higher electrochemical potential than that of the anolyte.

The embodiments relate to a two-dimensional (2D) separator system for use in a flow battery, and a flow battery utilizing such 2D separator system. The 2D separator system comprises a relatively thin layer of molecules, in one embodiment a sheet of graphene, having perforations of a size configured to facilitate transfer of a common counter ion between an anolyte and a catholyte, and to inhibit transfer of one or more electro-active ions between the anolyte and the catholyte. Among other advantages, the embodiments provide a 2D separator system for a flow battery that reduces area-specific resistance and greatly reduces or eliminates leakage of electro-active ions across the 2D separator system, increasing efficiency of the flow battery. The 2D separator system also has a high temperature tolerance and a high chemical resistance.

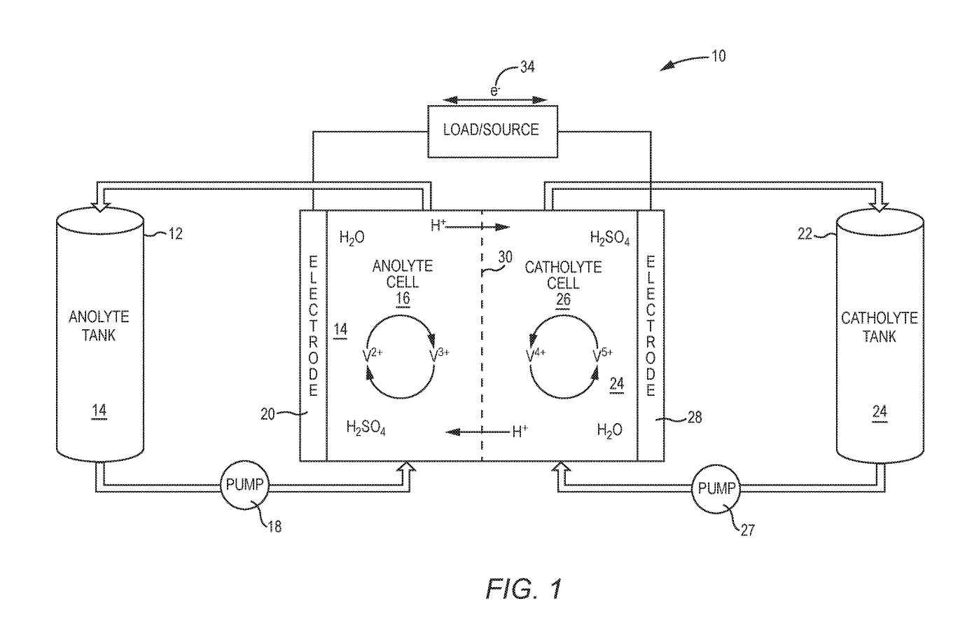

FIG. 1 is a high-level block diagram of a vanadium flow battery 10 utilizing a 2D separator system and a vanadium anolyte and a vanadium catholyte according to one embodiment. While for purposes of illustration vanadium is discussed herein as the particular reduction/oxidation electro-active species, it should be apparent that the embodiments have applicability to any electro-active species utilized in a flow battery. The flow battery 10 includes an anolyte tank 12 configured to maintain a negative electrolyte, sometimes referred to as an anolyte 14. An anolyte half-cell 16 is fluidically coupled to the anolyte tank 12, and a first pump 18 is configured to circulate the anolyte 14 between the anolyte tank 12 and the anolyte half-cell 16. A first electrode 20 is at least partially exposed to the anolyte half-cell 16. A catholyte tank 22 is configured to maintain a positive electrolyte, sometimes referred to as a catholyte 24. A catholyte half-cell 26 is fluidically coupled to the catholyte tank 22. A second pump 27 is configured to circulate the catholyte 24 between the catholyte tank 22 and the catholyte half-cell 26. A second electrode 28 is at least partially exposed to the catholyte half-cell 26.

A separator system 30 separates the anolyte half-cell 16 from the catholyte half-cell 26. In one embodiment, the separator system 30 comprises a sheet of graphene having a plurality of perforations. The plurality of perforations comprises a size configured to facilitate transfer of a common counter ion, in this example, a proton (H⁺) between the anolyte half-cell 16 and the catholyte half-cell 26. The plurality of perforations further comprises a size configured to inhibit transfer of one or more electro-active ions, in this example, various vanadium or vanadium oxide ions, between the anolyte half-cell 16 and the catholyte half-cell 26.

Two simultaneous reactions occur on both sides of the separator system 30. In a discharge mode of the flow battery 10, electrons 34 are removed in an oxidation process from the anolyte 14 in the anolyte half-cell 16 and transferred through the external circuit to the catholyte 24 in the catholyte half-cell 26. In a charge mode of the flow battery 10, the flow of electrons 34 is reversed, with a reduction process taking place in the anolyte 14 in the anolyte half-cell 16 and the oxidation process taking place in the catholyte 24 in the catholyte half-cell 26.

In some embodiments, the separator system 30 may be coupled to the first electrode 20 or the second electrode 28 to increase the exclusion of the electro-active species due to a double layer exclusion effect. In some embodiments, the edges of the perforations may be functionalized such that the perforations within the sheet of graphene are lined with one or more functional groups. In one embodiment the perforations within the sheet of graphene are lined with one or more functional groups comprising Fluorine. In other embodiments, the perforations within the sheet of graphene are lined with one or more functional groups that comprise cations, or with functional groups that comprise anions. In some embodiments, the perforations within the sheet of graphene are lined with a non-polar functional group comprising hydrogen, fluoride, alkyl, alkylene, phyenyl, or siloxane to be hydrophobic. In other embodiments, the plurality of perforations within the sheet of graphene are lined with a polar or ionic functional group comprising hydroxyl, sulfhydryl, carbonyl, ether, aldehyde, ketone, ester, carboxyl, amino, amide, or phosphate to be hydrophilic.

While solely for purposes of illustration FIG. 1 schematically depicts a single cell, the embodiments have applicability to multiple such cells in a stack, and potentially multiple stacks, with various parallel and serial power and fluidic connection architectures possible. Such multiple cells may be separated by bipolar plates.

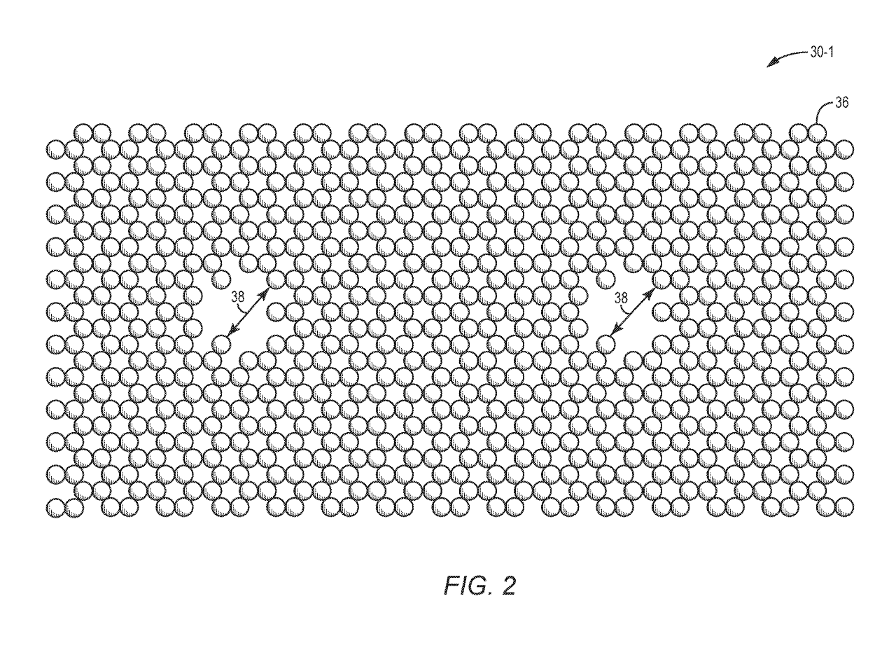

FIG. 2 is a diagram of a separator system 30-1 according to one embodiment. In this example, a graphene sheet 36 comprising a plurality of carbon atoms forms a plurality of perforations 38 sized to allow the passage of a common counter ion, such as a proton (H⁺) or a hydroxyl ion, and to inhibit the passage of one or more electro-active species, such as, in the example above, V²⁺, V³⁺, V⁴⁺, and V⁵⁺ ions. It will be appreciated that while certain examples of counter ions and electro-active species are discussed for purposes of illustration, the embodiments are not limited to any particular flow battery chemistry and have applicability to any counter ions, such as, by way of non-limiting example, alkali and alkaline, halogen, transition metals and their corresponding oxides, as well as any electro-active species.

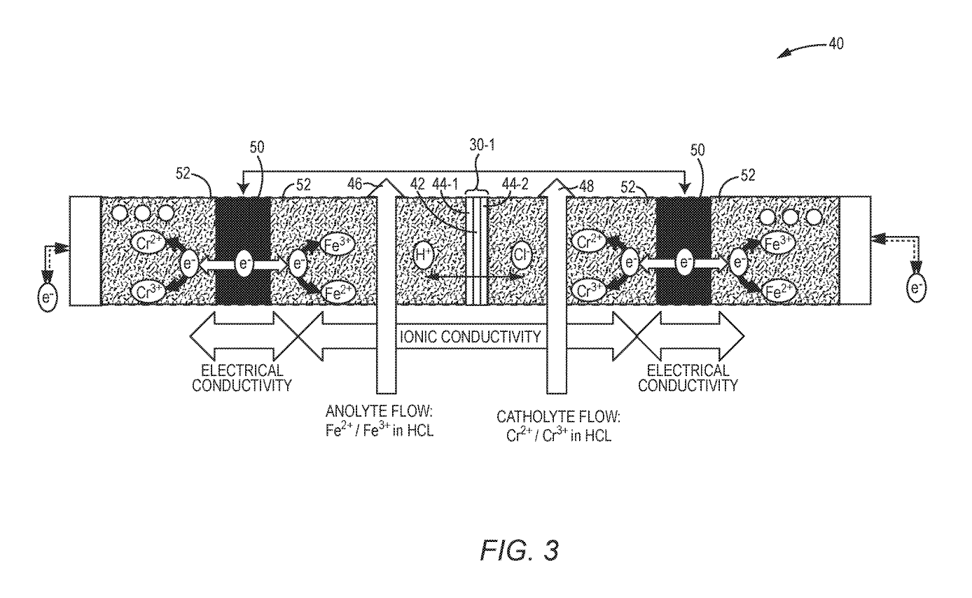

FIG. 3 is a block diagram of a flow battery cell 40 according to one embodiment. In this embodiment, the electro-active species comprises Fe²⁺, Fe³⁺, Cr²⁺, and Cr³⁺. The common counter ions comprise H⁺ and Cl⁻. In this example, the separator system 30-1 comprises a graphene sheet 42, a first polymer sheet 44-1 coupled to a first side of the graphene sheet 42, and a second polymer sheet 44-2 coupled to a second side of the graphene sheet 42. The first polymer sheet 44-1 and the second polymer sheet 44-2 each have a plurality of openings that have a greater diameter than the plurality of perforations in the graphene sheet 42. The first polymer sheet 44-1 and the second polymer sheet 44-2, among other advantages, provide mechanical stability to the graphene sheet 42. In other embodiments, other porous structures may be used to provide support to the graphene sheet 42. For example, in one embodiment an electrospun material is deposited directly on one or both sides of the graphene sheet 42.

The separator system 30-1 separates an anolyte flow 46 from a catholyte flow 48. In this example, the separator system 30-1 allows a flow of common counter ions H⁺ and Cl⁻ between the anolyte flow 46 and the catholyte flow 48. The separator system 30-1 inhibits the flow of the electro-active redox ion species Fe²⁺, Fe³⁺, Cr²⁺, and Cr³⁺. Each flow battery cell 40 is contained within a pair of bipolar plates 50, which are electrically conductive. It will be appreciated that the bipolar plates 50 are current collectors connected in a bipolar topology. Disposed adjacent to the bipolar plates 50 is an electrode 52. The electrode 52 provides catalyst sites where electrons from the bipolar plates 50 can reach the electro-active redox species of the anolyte flow 46 and the catholyte flow 48. The electrode 52 may comprise, for example, a woven or non-woven carbon, graphite, or similar material. The electrode 52 may be porous, allowing fluids, such as the anolyte 14 and/or catholyte 24, to flow through the electrode 52.

2D materials for use as a separator system 30, 30-1 include graphene, a graphene-based material, a transition metal dichalcogenide, molybdenum disulfide, α-boron nitride, silicene, germanene, MXenes (e.g., M₂X, M₃X₂, M₄X₃, where M is an early transition metal such as Sc, Ti, V, Zr, Cr, Nb, Mo, Hf and Ta and X is carbon and/or nitrogen) or a combination thereof. Other nanomaterials having an extended 2D planar molecular structure can also constitute the 2D material in various embodiments. For example, molybdenum disulfide is a representative chalcogenide having a 2D molecular structure, and other various chalcogenides can constitute the 2D material in some embodiments. In another example, 2D boron nitride can constitute the 2D material in some embodiments. Choice of a suitable 2D material for a particular application can be determined by a number of factors, including the chemical and physical environment into which the graphene, graphene-based, or other 2D material is to be deployed.

Graphene-based materials include, but are not limited to, single-layer graphene, multilayer graphene, or interconnected single-layer or multilayer graphene domains and combinations thereof. In some embodiments, multilayer graphene or graphene-based material includes 2 to 20 layers, 2 to 10 layers, or 2 to 5 layers. In some embodiments, graphene is the dominant material in a graphene-based material. For example, a graphene-based material comprises at least 30% graphene, or at least 40% graphene, or at least 50% graphene, or at least 60% graphene, or at least 70% graphene, or at least 80% graphene, or at least 90% graphene, or at least 95% graphene. In some embodiments, a graphene-based material comprises a range of graphene selected from 30% to 95%, or from 40% to 80%, or from 50% to 70%.

As used herein, a “domain” refers to a region of a material where atoms are uniformly ordered into a crystal lattice. A domain is uniform within its boundaries, but different from a neighboring region. For example, a single crystalline material has a single domain of ordered atoms. In some embodiments, at least some of the graphene domains are nanocrystals, having domain sizes from 1 to 100 nm or 10 to 100 nm. In some embodiments, at least some of the graphene domains have a domain size greater than 100 nm up to 1 micron, or from 200 nm to 800 nm, or from 300 nm to 500 nm. “Grain boundaries” formed by crystallographic defects at edges of each domain differentiate between neighboring crystal lattices. In some embodiments, a first crystal lattice may be rotated relative to a second crystal lattice by rotation about an axis perpendicular to the plane of a sheet, such that the two lattices differ in “crystal lattice orientation.”

In some embodiments, the sheet of graphene-based material comprises a sheet of single-layer or multilayer graphene or a combination thereof. In some embodiments, the sheet of graphene-based material is a sheet of single-layer or multilayer graphene or a combination thereof. In other embodiments, the sheet of graphene-based material is a sheet comprising a plurality of interconnected single-layer or multilayer graphene domains. In some embodiments, the interconnected domains are covalently bonded together to form the sheet. When the domains in a sheet differ in crystal lattice orientation, the sheet is polycrystalline.

In some embodiments, the thickness of the sheet of graphene-based material is from 0.34 to 10 nm, from 0.34 to 5 nm, or from 0.34 to 3 nm. A sheet of graphene-based material may include intrinsic defects. Intrinsic defects are those defects resulting unintentionally from preparation of the graphene-based material in contrast to perforations which are selectively introduced into a sheet of graphene-based material or a sheet of graphene. Such intrinsic defects include, but are not limited to, lattice anomalies, pores, tears, cracks, or wrinkles. Lattice anomalies can include, but are not limited to, carbon rings with other than 6 members (e.g. 5, 7, or 9 membered rings), vacancies, interstitial defects (including incorporation of non-carbon atoms in the lattice), and grain boundaries.

In some embodiments, the layer comprising the sheet of graphene-based material further comprises non-graphenic carbon-based material located on the surface of the sheet of graphene-based material. In an embodiment, the non-graphenic carbon-based material does not possess long-range order and may be classified as amorphous. In some embodiments, the non-graphenic carbon-based material further comprises elements other than carbon and/or hydrocarbons. Non-carbon materials that may be incorporated in the non-graphenic carbon-based material include, but are not limited to, hydrogen, hydrocarbons, oxygen, silicon, copper, and iron. In some embodiments, carbon is the dominant material in non-graphenic carbon-based material. For example, a non-graphenic carbon-based material comprises at least 30% carbon, or at least 40% carbon, or at least 50% carbon, or at least 60% carbon, or at least 70% carbon, or at least 80% carbon, or at least 90% carbon, or at least 95% carbon. In some embodiments, a non-graphenic carbon-based material comprises a range of carbon selected from 30% to 95%, or from 40% to 80%, or from 50% to 70%.

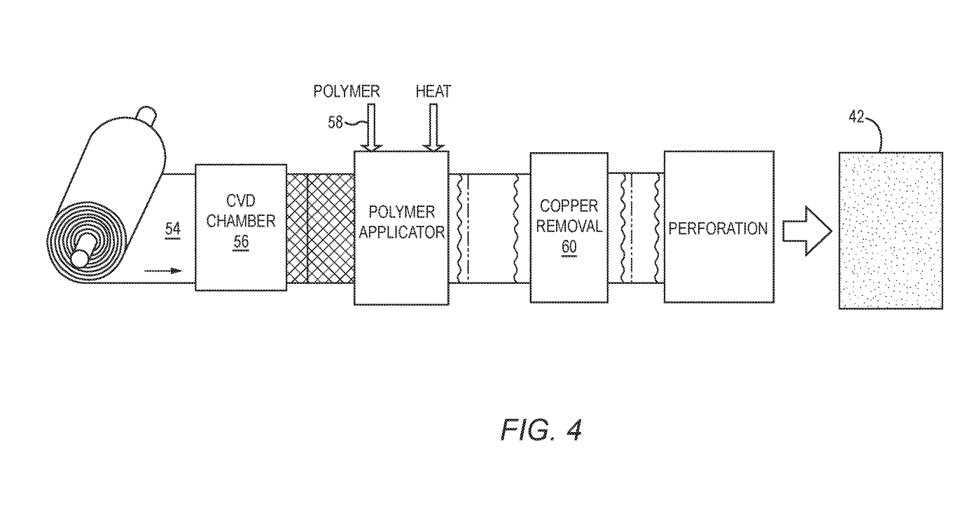

FIG. 4 is a block diagram of an illustrative system and process whereby graphene or graphene-based material can be synthesized, liberated from its growth substrate, and configured as a graphene-based separator system 30. As illustrated in FIG. 4, graphene or graphene-based material can be grown on a growth substrate 54 (e.g., a copper substrate) in a continuous process in a CVD cell 56, and a polymer 58 can subsequently be applied thereto. Thereafter, the growth substrate 54 can be removed (block 60), followed by perforation of the graphene or graphene-based material via a suitable technique. The number of perforations and their sizes can be regulated by choice of the conditions under which the perforations are produced, thereby providing graphene sheet material having perforations of desired sizes. The harvested perforated graphene or graphene-based material can be cut to various desired lengths based on its intended application.

The technique used for forming the graphene or graphene-based material in the embodiments described herein is not limited. For example, in some embodiments CVD graphene or graphene-based material can be used. In various embodiments, the CVD graphene or graphene-based material can be liberated from its growth substrate (e.g., Cu) and transferred to a polymer backing. Likewise, the techniques for introducing perforations to the graphene or graphene-based material are also not limited, other than being chosen to produce perforations within a desired size range. Illustrative perforation techniques can include plasma treatment and particle bombardment.

Perforations are sized to provide desired selective permeability of a species (molecule, ion, etc.) for a given flow battery chemistry. Selective permeability relates to the propensity of a porous material or a perforated two-dimensional material to allow passage (or transport) of one or more species more readily or faster than other species. Selective permeability allows separation of species which exhibit different passage or transport rates. In 2D materials, selective permeability correlates to the dimension or size (e.g., diameter) of apertures and the relative effective size of the species. Selective permeability of the perforations in 2D materials, such as graphene-based materials, can also depend on functionalization of perforations (if any) and the specific species that are to be separated. Separation of two species in a mixture includes a change in the ratio (weight or molar ratio) of the two species in the mixture after passage of the mixture through a perforated 2D material. The perforations may be functionalized to have a desired characteristic, such as to be hydrophobic or hydrophilic.

For example, in applications for separation of water from other species, the molecular diameter of water is about 2.9 Å, as determined from interpolation of the effective ionic radii of isoelectric ions from crystal data, and the mean van der Waals diameter of water, which accounts for electron distribution, is approximately 2.8-3.2 Å. Perforations dimensioned to be about 2.8 angstroms or more should exhibit permeability to water, and permeability to water should increase with perforation dimension. The range of perforation size employed depends upon other species present in the medium from which water is to be removed. In specific embodiments, perforations are dimensioned to range between about 2.5 and 5 angstroms. In other embodiments, perforations are dimensioned to range between about 3 and 5 angstroms. In other embodiments, perforations are dimensioned to range between about 3 and 10 angstroms. In other embodiments, perforations are dimensioned to range from about 5 to 20 angstroms. It will be appreciated that perforations can be otherwise dimensioned dependent upon the species that are present in the medium from which water is to be removed. Perforations of a selected size can have a 1-10% deviation or a 1-20% deviation from the selected size. For circular holes, the characteristic dimension is the diameter of the hole. In embodiments relevant to non-circular pores, the characteristic dimension can be taken as the largest distance spanning the hole, the smallest distance spanning the hole, the average of the largest and smallest distances spanning the hole, or an equivalent diameter based on the in-plane area of the pore. As used herein, perforated graphene-based materials include materials in which non-carbon atoms have been incorporated at the edges of the pores. The size of the perforations is based on the particular electro-active species being used. By way of non-limiting example, if the electro-active species comprises Na and K, the perforations may be sized between about 0.4 and about 0.6 nm.

Those skilled in the art will recognize improvements and modifications to the preferred embodiments of the disclosure. All such improvements and modifications are considered within the scope of the concepts disclosed herein and the claims that follow.

What is claimed is:

1. A flow battery comprising:
an anolyte tank configured to maintain an anolyte;
an anolyte half-cell fluidically coupled to the anolyte tank;
a first pump configured to circulate the anolyte between the anolyte tank and the anolyte half-cell;
a first electrode at least partially exposed to the anolyte half-cell;
a catholyte tank configured to maintain a catholyte;
a catholyte half-cell fluidically coupled to the catholyte tank;
a second pump configured to circulate the catholyte between the catholyte tank and the catholyte half-cell; and
a second electrode at least partially exposed to the catholyte half-cell;
a separator system separating the anolyte half-cell from the catholyte half-cell, the separator system comprising:
a sheet of two-dimensional (2D) material having perforations, the perforations comprising a size configured to facilitate transfer of a common counter ion between the anolyte and the catholyte, and to inhibit transfer of one or more electro-active ions between the anolyte and the catholyte.

2. The flow battery of claim 1, wherein the separator system further comprises a support structure configured to support the sheet of 2D material.

3. The flow battery of claim 2, wherein the support structure comprises a first polymer sheet having a plurality of openings that have a greater diameter than a diameter of the perforations of the sheet of 2D material, and wherein the sheet of 2D material has a first side and a second side, and the first polymer sheet is coupled to the first side.

4. The flow battery of claim 3, wherein the support structure further comprises a second polymer sheet having a plurality of openings that have a greater diameter than a diameter of the perforations of the sheet of 2D material, and wherein the second polymer sheet is coupled to the second side.

5. The flow battery of claim 1, wherein the common counter ion comprises a proton or a hydroxyl ion.

6. The flow battery of claim 1, wherein the anolyte comprises Fe²⁺ and Fe³⁺.

7. The flow battery of claim 1, wherein the sheet of 2D material has a thickness less than or equal to 1 nanometer.

8. The flow battery of claim 1, wherein the perforations within the sheet of 2D material are lined with a hydrophobic functional group.

9. The flow battery of claim 8, wherein the hydrophobic functional group comprises one or more of hydrogen, fluoride, alkyl, alkylene, phyenyl, or siloxane.

10. The flow battery of claim 1, wherein the perforations within the sheet of 2D material are lined with a hydrophilic functional group.

11. The flow battery of claim 10, wherein the hydrophilic functional group comprises one or more of hydroxyl, sulfhydryl, carbonyl, ether, aldehyde, ketone, ester, carboxyl, amino, amide, or phosphate.

12. The flow battery of claim 1, wherein the perforations within the sheet of 2D material are lined with a functional group including Fluorine.

13. The flow battery of claim 1, wherein the sheet of 2D material is electrically coupled to the first electrode.

14. The flow battery of claim 1, wherein the sheet of 2D material comprises graphene.

15. A separator system for a flow battery comprising:
a sheet of 2D material having perforations, the perforations comprising a size configured to facilitate transfer of a common counter ion between an anolyte and a catholyte, and to inhibit transfer of one or more electro-active ions between the anolyte and the catholyte.

16. The separator system of claim 15, further comprising a support structure configured to support the sheet of 2D material.

17. The separator system of claim 16, wherein the support structure comprises a first polymer sheet having a plurality of openings that have a greater diameter than a diameter of the perforations of the sheet of 2D material, and wherein the sheet of 2D material has a first side and a second side, and the first polymer sheet is coupled to the first side.

18. The separator system of claim 17, wherein the support structure further comprises a second polymer sheet having a plurality of openings that have a greater diameter than a diameter of the perforations of the sheet of 2D material, and wherein the second polymer sheet is coupled to the second side.

19. The separator system of claim 15, wherein the common counter ion comprises a proton or a hydroxyl ion.

20. The separator system of claim 15, wherein the anolyte comprises Fe²⁺ and Fe^{3'}.

21. The separator system of claim 15, wherein the sheet of 2D material has a thickness less than or equal to 1 nanometer.

22. The separator system of claim 15, wherein the perforations within the sheet of 2D material are lined with a hydrophobic functional group.

23. The separator system of claim 15, wherein the perforations within the sheet of 2D material are lined with a hydrophilic functional group.

24. The separator system of claim 15, wherein the perforations within the sheet of 2D material are lined with a functional group including Fluorine.

25. The separator system of claim 15, wherein the sheet of 2D material comprises graphene.
